(19) United States
(12) Patent Application Publication
(10) Pub. No.: US 2019/0028522 A1
(43) Pub. Date: Jan. 24, 2019

(54) TRANSMISSION OF SUBTITLE DATA FOR WIRELESS DISPLAY

(71) Applicant: QUALCOMM Incorporated, San Diego, CA (US)

(72) Inventors: Amit Kumar, Hyderabad (IN); Praveen Singh Sisodia, Hyderabad (IN); Kailash Chandra Singh Rawat, Hyderabad (IN)

(21) Appl. No.: 16/036,255

(22) Filed: Jul. 16, 2018

Related U.S. Application Data
(60) Provisional application No. 62/534,466, filed on Jul. 19, 2017.

(51) Int. Cl. H04L 29/06

(52) U.S. Cl. CPC H04L 65/4069; H04W 84/12

(57) ABSTRACT

An example source device includes a transceiver, a memory, and processor(s) in communication with the memory and the transceiver. The memory stores an application framework and subtitle information associated with the application framework. The processor(s) are configured to execute the application framework stored to the memory, to receive the subtitle information from the application framework, to initiate, in response to the receipt of the subtitle information, via the transceiver, a negotiation of features between the wireless source device and a sink device, to obtain negotiated features based on the negotiation of features, to capture, in response to obtaining the negotiated features, subtitle text data in accordance with the set of negotiated features, and to transmit, via the transceiver, the captured subtitle text data to the sink device.

This application claims the benefit of U.S. Provisional Application No. 62/534,466, filed 19 Jul. 2017, the entire content of which is incorporated herein by reference.

### TECHNICAL FIELD

This disclosure relates to techniques for transmitting data between a wireless source device and a wireless sink device.

### BACKGROUND

Wireless display (WD) or Wi-Fi Display (WFD) systems include a wireless source device and one or more wireless sink devices. The source device and each of the sink devices may be either mobile devices or wired devices with wireless communication capabilities. One or more of the source device and the sink devices may, for example, may include mobile telephones, portable computers with wireless communication cards, personal digital assistants (PDAs), portable media players, or other such devices with wireless communication capabilities, including so-called “smart” phones and “smart” pads or tablets, e-readers, or any type of wireless display, video gaming devices, or other types of wireless communication devices. One or more of the source device and the sink devices may also include wired devices such as televisions, desktop computers, monitors, projectors, and the like, that include communication capabilities.

Recent advances have been made to allow direct streaming of video and audio directly from one wireless communication enabled device to another. One such system is known as “Miracast.” Miracast is a trademark for a wireless (e.g., IEEE 802.11 family of wireless protocols or “Wi-Fi”) display protocol promulgated by the Wi-Fi Alliance. As used herein, the term Miracast refers to the current form of the Wi-Fi Alliance's display sharing protocol, also known as Wi-Fi Display (WFD).

The Miracast specification is designed for streaming any type of video bitstream from a source device to a sink device. As one example, a source may be a smart phone, and a sink may be a television set. Although in typical IEEE 802.11 wireless networks, client devices communicate through an access point (AP) device, protocols exist (such as Wi-Fi Direct) that support direct device communications. The Miracast system uses such protocols for sending display data from one device to another, such as from a smart phone to a television or computer, or vice-versa. The Miracast system involves sharing the contents of a frame buffer and speaker audio of the source device to a remote display/speaker device (sink) over a Wi-Fi connection.

In one example, the Miracast protocol involves the source capturing the RGB data from the frame buffer and any Pulse Coded Modulation (PCM) audio data from the audio subsystem. The content of the frame buffer may be derived from application programs or a media player running on the source. The source then compresses the video and audio content, and transmits the data to the sink device. On receiving the bitstream, the sink decodes and renders it on its local display and speakers.

When a user plays an audio/video clip locally on a Miracast capable source device, the bitstream is decoded and rendered locally on the source display and then the audio/video content is captured, re-encoded and streamed to a Miracast capable sink device at the same time. The sink device then decodes and renders the same content on its display and speakers. Such operation is often called the “mirroring” mode.

### SUMMARY

This disclosure generally describes a system where a wireless source device can communicate with a wireless sink device. As part of a communication session, a wireless source device can transmit audio and video data to the wireless sink device using a wireless display protocol, such as the Miracast wireless display protocol. For example, a source device operating according to the Miracast wireless display protocol, while in direct streaming mode, may receive subtitle text data from an application framework of the source device, and upon receiving the details of the subtitle text data, negotiate with the sink device for respective format, and continue on successful negotiation. The subtitle text data is then sent to the application framework of the sink device and subtitle text data is captured at the source device in response to the negotiated features, encoded and transmitted to the sink device. The captured subtitle text data may be multiplexed into a data stream prior to being transmitted to the sink device.

The sink device subsequently receives the transmitted data stream, transfers the subtitle text data to an application framework executing on the sink device, decodes the subtitle text data at the application framework, and displays the decoded subtitle text on a display of the sink device.

As a result, power savings are may be achieved at the source device by periodically eliminating and/or reducing the need for composing and presenting data onto a display of the source device, eliminating and/or reducing the need for write back by the source device display to provide raw data, eliminating and/or reducing pixel wise operation on raw data to optimize performance, and eliminating and/or reducing the need for encoding (e.g., PNG/JPEG encoding) of subtitle data and/or upward or downward scaling of decoded subtitle data based on screen resolution. In addition, the quality of the subtitle data may be improved, as a subtitle is typically not resized, and is rendered natively at the sink device. As a result, the quality of text is not distorted or skewed as the display at the sink device is typically larger in size and of higher resolution.

In one example, a method of transmitting subtitle data in a wireless display system includes receiving, at a source device, subtitle information from an application framework running on the source device, initiating, in response to receiving the subtitle information, by the source device, a negotiation of features associated with the subtitle information between the source device and a sink device, and obtaining, by the source device, negotiated features based on the negotiation of features between the source device and the sink device. The method further includes capturing, in response to obtaining the negotiated features, by the source device, subtitle text data in accordance with the negotiated features, and transmitting, by the source device, the captured subtitle text data to the sink device.

In another example, a wireless source device includes a transmitter/receiver, a memory, and one or more processors in communication with the memory and the transmitter/receiver. The transmitter/receiver is configured to couple the wireless source device with a wireless sink device. The memory is configured to store an application framework and subtitle information associated with the application framework. The one or more processors are configured to execute the application framework stored to the memory, to receive the subtitle information from the application framework, and to initiate, in response to the receipt of the subtitle information, via the transmitter/receiver, a negotiation of features between the wireless source device and the wireless sink device. The one or more processors are further configured to obtain negotiated features based on the negotiation of features, to capture, in response to obtaining the negotiated features, subtitle text data in accordance with the set of negotiated features, and to transmit, via the transmitter/receiver, the captured subtitle text data to the wireless sink device.

In another example, a wireless display system includes a source device and a sink device. The source device is configured to obtain subtitle information from a first application framework, the first application framework representing at least one application running on the source device, and in response to receiving the subtitle information, initiate a negotiation of features associated with the subtitle information. The sink device is configured to complete the negotiation of features initiated by the source device, to receive, from the source device, subtitle text data in accordance with the negotiated features, to transfer the received subtitle text data to a second application framework, the second application framework representing at least one application running on the sink device, to render the subtitle text data using the second application framework to form rendered subtitle text, and to output the rendered subtitle text for display.

In another example, a wireless display system includes means for obtaining, at a source device of the wireless display system, subtitle information from a first application framework, the first application framework representing at least one application running on the source device, means for initiating, at the source device, in response to receiving the subtitle information, a negotiation of features associated with the subtitle information, means for completing, at a sink device of the wireless display system, the negotiation of features initiated at the source device, means for receiving, at the sink device and from the source device, subtitle text data in accordance with the negotiated features, means for transferring, at the sink device, the received subtitle text data to a second application framework, the second application framework representing at least one application running on the sink device, means for rendering, at the sink device, the subtitle text data using the second application framework to form rendered subtitle text, and means for outputting the rendered subtitle text for display via the sink device.

In another example, a wireless sink device configured to receive subtitle text data from a source device includes a transmitter/receiver configured to receive the subtitle text data from the source device; a decoder to decode data; an application framework module within the decoder to run a software application on the sink device; and a display to display data, wherein the decoder is configured to transfer the received transmitted captured subtitle text data to the application framework to decode the subtitle text data, render the decoded subtitle text data at the application framework to subtitle text, and cause the subtitle text to be displayed by the display.

In another example, a computer-readable storage medium storing instructions that upon execution by one or more processors cause the one or more processors to perform a method of transmitting user input data from a wireless sink device to a wireless source device, the method comprising receiving, at a source device, subtitle text data from an application framework of the source device; initiating, in response to the received subtitle data, negotiation of features of the subtitle text data between the source device and a sink device; transferring the resulting negotiated features to the application framework of the source device; capturing subtitle text data at the source device in response to the transferred negotiated features; and transmitting the captured subtitle text data to the sink device.

The details of one or more examples of the techniques are set forth in the accompanying drawings and the description below. Other features, objects, and advantages of the techniques will be apparent from the description, drawings, and from the claims.

### BRIEF DESCRIPTION OF DRAWINGS

FIG. 1 is a block diagram illustrating an example of a source/sink system that may implement techniques of this disclosure.

FIG. 2 shows an example of a source device that may implement techniques of this disclosure.

FIG. 3 shows an example of a sink device that may implement techniques of this disclosure.

FIG. 4 is a block diagram showing one example of a sink device of a wireless display system that may implement one or more techniques of this disclosure.

FIG. 5 is a block diagram of a source device of a wireless display system for transmitting subtitle data according to an example of the present disclosure.

FIG. 6 is a block diagram of a sink device of a wireless display system for transmitting subtitle data according to an example of the present disclosure.

FIG. 7 is a flowchart of a method of transmitting subtitle data in a wireless display system according to an example of the present disclosure.

FIG. 8 is a flowchart of a method of transmitting subtitle data in a wireless display system according to an example of the present disclosure.

### DETAILED DESCRIPTION

This disclosure generally describes a system where a wireless source device can communicate with a wireless sink device. As part of a communication session, a wireless source device can transmit audio and video data to the wireless sink device using a wireless display protocol, e.g., the Miracast wireless display protocol. For example, a Miracast source device, while in direct streaming mode, may receive subtitle text data from an application framework of the source device, and upon receiving the details of the subtitle text data, negotiate with a sink device for a respective format for sending the subtitle data, and continue on successful negotiation. The subtitle text data is then sent to the application framework of the source device and subtitle text data is captured at the source device in response to the negotiated features, encoded and transmitted to the sink device. The captured subtitle text data may be multiplexed into a data stream prior to being transmitted to the sink device.

The sink device subsequently receives the transmitted data stream, transfers the subtitle text data to an application framework located on the sink device, decodes the subtitle text data at the application framework, and displays the decoded subtitle text (e.g., together with synchronized video data) on a display of the sink device.

As a result, power savings may be achieved at both the source device and sink device by periodically eliminating the need for composing and presenting data onto a display of the source device, eliminating the need for write back by the source device display to provide raw data, eliminating pixel wise operation on raw data to optimize performance, and eliminating the need for PNG/JPEG encoding/decoding and upward or downward scaling based on screen resolution. In addition, quality of the subtitle data may be improved as a subtitle is typically not resized, and is rendered natively at the sink device so that the quality of text is not distorted or skewed as the display at the sink device is typically larger in size and of higher resolution.

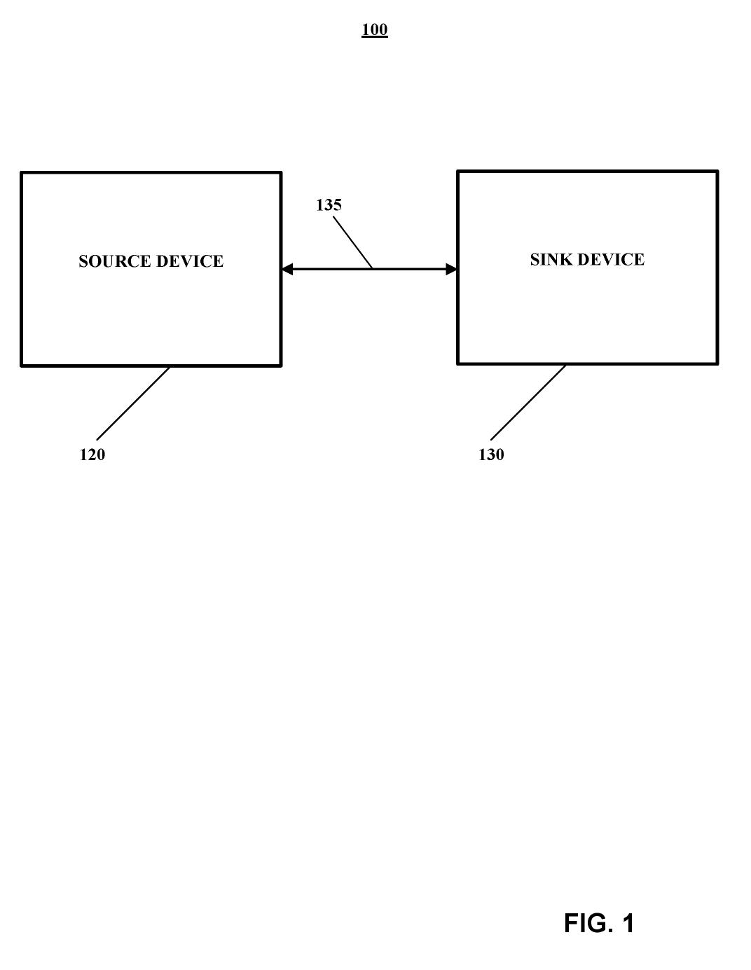

FIG. 1 is a block diagram illustrating an example of a wireless display system that may implement one or more techniques of this disclosure. As illustrated in FIG. 1, wireless display system 100 includes a source device 120 and a sink device 130 that are wirelessly connected via a wireless link 135. Examples of the source device 120 may include, but are not limited to, smartphones, cell phones, wireless headphones, wearable computing devices, tablets, personal digital assistants (PDAs), laptops, or any other device capable of communicating with a sink device via a connection (e.g., wired, cellular wireless, Wi-Fi, etc.). Examples of the sink devices 130 may include, but are not limited to, in-vehicle infotainment devices, TVs, computers, laptops, projectors, cameras, smartphones, wearable computing devices, or any other device capable of communicating with a source device 120 and displaying content received from the source device 120. The sink device 130 may be a combination of devices. For example, the sink device 130 may include a display device and a separate device for receiving, buffering, and decoding content for display on the display device.

In one example, link 135 connecting source device 120 and sink device 130 is a Wi-Fi Display connection that utilizes a wireless display protocol, such as the Miracast wireless display protocol, for example, which allows a portable device or computer to transmit video and audio to a compatible display wirelessly, and enables delivery of compressed standard or high-definition video over a wireless link 135. Miracast allows users to echo the display from one device onto the display of another device by video and/or audio content streaming. The link 135 between the source device 120 and sink device 130 may be bi-directional. In one configuration, the connection between the source device 120 and the sink device 130 may also allow users to launch applications stored on the source device 120 via the sink device 139. For example, the sink device 130 may include various input controls (e.g., mouse, keyboard, knobs, keys, user interface buttons). These controls may be used at the sink device 130 to initialize and interact with applications stored on the source device 120.

Miracast may use a transport stream such as an MPEG2 Transport Stream (MPEG-TS). The content may be encoded according to a media encoding format (e.g., h.264, MPEG-4, etc.) and may be multiplexed into the transport stream with other information (e.g., error correction, stream synchronization, etc.) for transmission to the sink device 130. The source device 120 may maintain a shared clock reference and periodically transmit the reference clock time in the transport stream. The sink device 130 may synchronize a local shared clock reference to the clock reference of the source device 120 using the periodically transmitted reference clock time values. The source device 120 may encode frames of the transport stream with reference values used by the sink device 130 to re-order the frames for decoding and to synchronize output of the media stream relative to the shared reference clock.

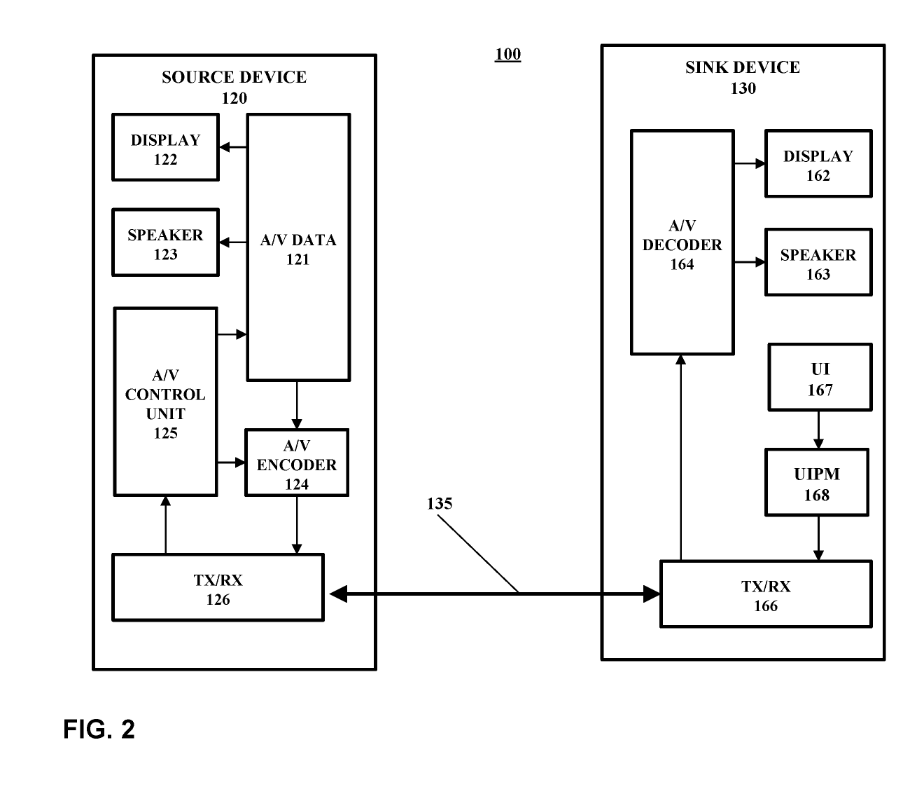

FIG. 2 is a block diagram illustrating an exemplary wireless display system that may implement one or more of the techniques of this disclosure. As shown in FIG. 2, wireless display 100 includes source device 120 that communicates with sink device 130 via wireless link 135. Source device 120 may include a memory that stores audio/video (A/V) data 121, display 122, speaker 123, audio/video encoder 124 (also referred to as encoder 124), audio/video control unit 125, and transmitter/receiver (TX/RX) unit 126. Sink device 130 may include display 162, speaker 163, audio/video decoder 164 (also referred to as decoder 164), transmitter/receiver unit 166, user input (UI) device 167, and user input processing (UIP) unit 168. The illustrated components constitute merely one example configuration for wireless display system 100. Other configurations may include fewer components than those illustrated or may include additional components than those illustrated.

In the example of FIG. 2, source device 120 can display the video portion of audio/video data 121 on display 122 and can output the audio portion of audio/video data 121 on speaker 123. Audio/video data 121 may be stored locally on source device 120, accessed from an external storage medium such as a file server, hard drive, external memory, Blu-ray disc, DVD, or other physical storage medium, or may be streamed to source device 120 via a network connection such as the internet. In some instances, audio/video data 121 may be captured in real-time via a camera and microphone of source device 120. Audio/video data 121 may include multimedia content such as movies, television shows, or music, but may also include real-time content generated by source device 120. Such real-time content may for example be produced by applications running on source device 120, or video data captured, e.g., as part of a video telephony session.

In addition to rendering audio/video data 121 locally via display 122 and speaker 123, audio/video encoder 124 of source device 120 can encode audio/video data 121, and transmitter/receiver unit 126 can transmit the encoded data over communication channel 135 to sink device 130. Transmitter/receiver unit 166 of sink device 130 receives the encoded data, and audio/video decoder 164 decodes the encoded data and outputs the decoded data via display 162 and speaker 163. In this manner, the audio and video data being rendered by display 122 and speaker 123 can be simultaneously rendered by display 162 and speaker 163. The audio data and video data may be arranged in frames, and the audio frames may be time-synchronized with the video frames when rendered.

Audio/video encoder 124 and audio/video decoder 164 may implement any number of audio and video compression standards, such as the ITU-T H.264 standard, alternatively referred to as MPEG-4, Part 10, Advanced Video Coding (AVC), or the newly emerging high efficiency video coding (HEVC) standard, sometimes called the H.265 standard. Many other types of proprietary or standardized compression techniques may also be used. Generally speaking, audio/video decoder 164 is configured to perform the reciprocal coding operations of audio/video encoder 124. Although not shown in FIG. 2, in some aspects A/V encoder 124 and A/V decoder 164 may each be integrated with an audio encoder and decoder, and may include appropriate MUX-DEMUX units, or other hardware and software, to handle encoding of both audio and video in a common data stream or separate data streams.

A/V encoder 124 may also perform other encoding functions in addition to implementing a video compression standard as described above. For example, A/V encoder 124 may add various types of metadata to A/V data 121 prior to A/V data 121 being transmitted to sink device 160. In some instances, A/V data 121 may be stored on or received at source device 120 in an encoded form and thus not require further compression by A/V encoder 124.

Audio/video encoder 124 and audio/video decoder 164 each may be implemented as one or more microprocessors, digital signal processors (DSPs), application specific integrated circuits (ASICs), field programmable gate arrays (FPGAs), processing circuitry (including fixed function circuitry and/or programmable processing circuitry), discrete logic, software, hardware, firmware or any combinations thereof. Each of audio/video encoder 124 and audio/video decoder 164 may be included in one or more encoders or decoders, either of which may be integrated as part of a combined encoder/decoder (CODEC). Thus, each of source device 120 and sink device 130 may comprise specialized machines configured to execute one or more of the techniques of this disclosure.

Display 122 and display 162 may comprise any of a variety of video output devices such as a cathode ray tube (CRT), a liquid crystal display (LCD), a plasma display, a light emitting diode (LED) display, an organic light emitting diode (OLED) display, or another type of display device. In these or other examples, the displays 122 and 162 may each be emissive displays or transmissive displays. Display 122 and display 162 may also be touch displays such that they are simultaneously both input devices and display devices. Such touch displays may be capacitive, resistive, or other type of touch panel that allows a user to provide user input to the respective device.

Speaker 123 may comprise any of a variety of audio output devices such as headphones, a single-speaker system, a multi-speaker system, or a surround sound system. Additionally, although display 122 and speaker 123 are shown as part of source device 120 and display 162 and speaker 163 are shown as part of sink device 130, source device 120 and sink device 130 may in fact be a system of devices. As one example, display 162 may be a television, speaker 163 may be a surround sound system, and decoder 164 may be part of an external box connected, either wired or wirelessly, to display 162 and speaker 163. In other instances, sink device 130 may be a single device, such as a tablet computer or smartphone. In still other cases, source device 120 and sink device 130 are similar devices, e.g., both being smartphones, tablet computers, or the like. In this case, one device may operate as the source and the other may operate as the sink. These rolls may even be reversed in subsequent communication sessions. In still other cases, the source device may comprise a mobile device, such as a smartphone, laptop or tablet computer, and the sink device may comprise a more stationary device (e.g., with an AC power cord), in which case the source device may deliver audio and video data for presentation to a large crowd via the sink device.

Transmitter/receiver unit 126 and transmitter/receiver unit 166 may each include various mixers, filters, amplifiers and other components designed for signal modulation, as well as one or more antennas and other components designed for transmitting and receiving data. Wireless link 135 generally represents any suitable communication medium, or collection of different communication media, for transmitting video data from source device 120 to sink device 130. Wireless link 135 is usually a relatively short-range communication channel, similar to Wi-Fi, Bluetooth, or the like. In other examples, wireless link 135 may even form part of a packet-based network, such as a wired or wireless local area network, a wide-area network, or a global network such as the Internet. Additionally, wireless link 135 may be used by source device 120 and sink device 160 to create a peer-to-peer link. Source device 120 and sink device 130 may communicate over wireless link 135 using a communications protocol such as a standard from the IEEE 802.11 family of standards. Source device 120 and sink device 130 may, for example, communicate according to the Wi-Fi Direct standard, such that source device 120 and sink device 130 communicate directly with one another without the use of an intermediary such as a wireless access points or so called hotspot. Source device 120 and sink device 130 may also establish a tunneled direct link setup (TLDS) to avoid or reduce network congestion. WiFi Direct and TDLS are intended to setup relatively short-distance communication sessions. Relatively short distance in this context may refer to, for example, less than 70 meters, although in a noisy or obstructed environment the distance between devices may be even shorter, such as less than 35 meters.

In addition to decoding and rendering data received from source device 120, sink device 130 can also receive user inputs from user input device 167. User input device 167 may, for example, be a keyboard, mouse, trackball or track pad, touch screen, voice command recognition module, or any other such user input device. UIP UNIT 168 formats user input commands received by user input device 167 into a data packet structure that source device 120 is capable of interpreting. Such data packets are transmitted by transmitter/receiver 166 to source device 120 over wireless link 135. Transmitter/receiver unit 126 receives the data packets, and A/V control unit 125 parses the data packets to interpret the user input command that was received by user input device 167. Based on the command received in the data packet, A/V control unit 125 can change the content being encoded and transmitted. In this manner, a user of sink device 130 can control the audio payload data and video payload data being transmitted by source device 120 remotely and without directly interacting with source device 120. Examples of the types of commands a user of sink device 130 may transmit to source device 120 include commands for rewinding, fast forwarding, pausing, and playing audio and video data, as well as commands for zooming, rotating, scrolling, and so on. Users may also make selections, from a menu of options for example, and transmit the selection back to source device 120.

Additionally, users of sink device 130 may be able to launch and control applications on source device 120. For example, a user of sink device 130 may able to launch a photo editing application stored on source device 120 and use the application to edit a photo that is stored locally on source device 120. Sink device 130 may present a user with a user experience that looks and feels like the photo is being edited locally on sink device 130 while in fact the photo is being edited on source device 120. Using such a configuration, a device user may be able to leverage the capabilities of one device for use with several devices. For example, source device 120 may be a smartphone with a large amount of memory and high-end processing capabilities. A user of source device 120 may use the smartphone in all the settings and situations smartphones are typically used. When watching a movie, however, the user may wish to watch the movie on a device with a bigger display screen, in which case sink device 130 may be a tablet computer or even larger display device or television. When wanting to send or respond to email, the user may wish to use a device with a keyboard, in which case sink device 130 may be a laptop. In both instances, the bulk of the processing may still be performed by source device 120 (a smartphone in this example) even though the user is interacting with a sink device. In this particular operating context, due to the bulk of the processing being performed by source device 120, sink device 130 may be a lower cost device with fewer resources than if sink device 130 were being asked to do the processing being done by source device 120. Both the source device and the sink device may be capable of receiving user input (such as touch screen commands) in some examples, and the techniques of this disclosure may facilitate two-way interaction by negotiating and or identifying the capabilities of the devices in any given session.

In some configurations, A/V control unit 125 may be an operating system process being executed by the operating system of source device 120, as described below in detail. In other configurations, however, A/V control unit 125 may be a software process of an application running on source device 120. In such a configuration, the user input command may be interpreted by the software process, such that a user of sink device 130 is interacting directly with the application running on source device 120, as opposed to the operating system running on source device 120. By interacting directly with an application as opposed to an operating system, a user of sink device 130 may have access to a library of commands that are not native to the operating system of source device 120. Additionally, interacting directly with an application may enable commands to be more easily transmitted and processed by devices running on different platforms.

In the example of FIG. 2, source device 120 may comprise a smartphone, tablet computer, laptop computer, desktop computer, Wi-Fi enabled television, or any other device capable of transmitting audio and video data. Sink device 130 may likewise comprise a smartphone, tablet computer, laptop computer, desktop computer, Wi-Fi enabled television, or any other device capable of receiving audio and video data and receiving user input data. In some instances, sink device 130 may include a system of devices, such that display 162, speaker 163, UI device 167, and A/V encoder 164 all parts of separate but interoperative devices. Source device 120 may likewise be a system of devices rather than a single device.

In this disclosure, the term source device is generally used to refer to the device that is transmitting audio/video data, and the term sink device is generally used to refer to the device that is receiving the audio/video data from the source device. In many cases, source device 120 and sink device 130 may be similar or identical devices, with one device operating as the source and the other operating as the sink. Moreover, these rolls may be reversed in different communication sessions. Thus, a sink device in one communication session may become a source device in a subsequent communication session, or vice versa.

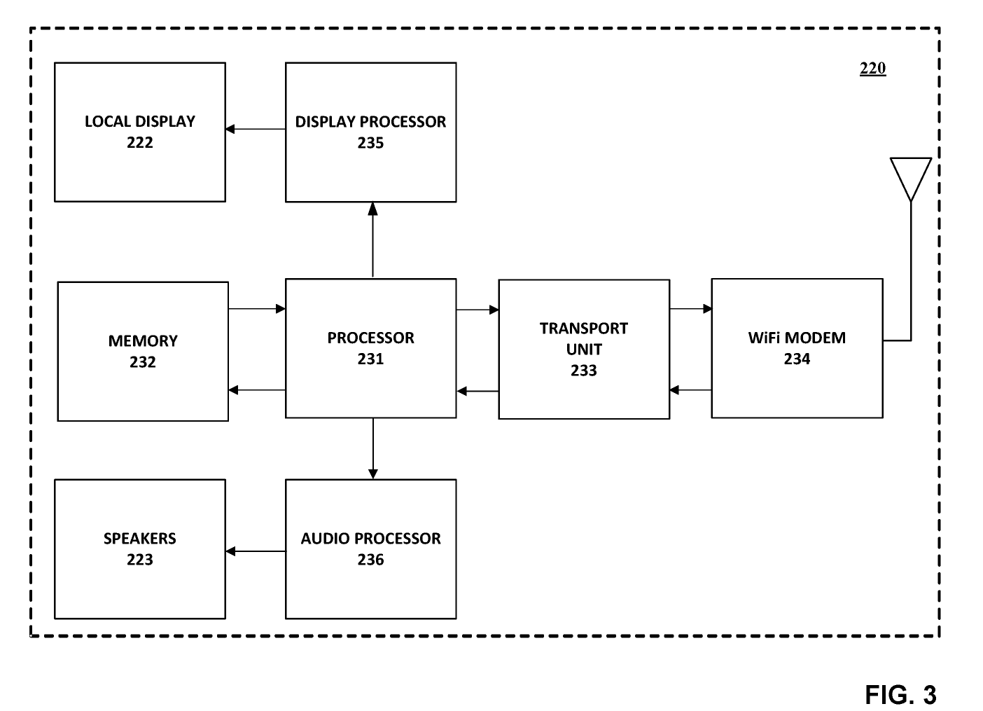

FIG. 3 is a block diagram showing one example of a source device of a wireless display system that may implement one or more techniques of this disclosure. As illustrated in FIG. 3, a source device 220, which may be a device similar to source device 120 in FIG. 2 and may operate in the same manner as source device 120, includes a local display 222, a local speaker 223, one or more processors 231, a memory 232, a transport unit 233, and a wireless modem 234. The one or more processors 231 may encode and/or decode A/V data for transport, storage, and display. The A/V data may for example be stored at memory 232. Memory 232 may store an entire A/V file, or may comprise a smaller buffer that simply stores a portion of an A/V file, e.g., streamed from another device or source. Transport unit 233 may process encoded A/V data for network transport. For example, encoded A/V data may be processed by processor 231 and encapsulated by transport unit 233 into Network Access Layer (NAL) units for communication across a network. The NAL units may be sent by wireless modem 234 to a wireless sink device via a network connection. Wireless modem 234 may, for example, be a Wi-Fi modem configured to implement one of the IEEE 802.11 family of standards.

Source device 220 may also locally process and display A/V data. In particular display processor 235 may process video data to be displayed on local display 222, audio processor 236 may process audio data for output on speaker 223.

As described above with reference to source device 120 of FIG. 2, source device 220 may also receive user input commands from a sink device. In this manner, wireless modem 234 of source device 220 receives encapsulated data packets, such as NAL units, and sends the encapsulated data units to transport unit 233 for decapsulation. For instance, transport unit 233 may extract data packets from the NAL units, and processor 231 can parse the data packets to extract the user input commands. Based on the user input commands, processor 231 can adjust the encoded A/V data being transmitted by source device 220 to a sink device. In this manner, the functionality described above in reference to A/V control unit 125 of FIG. 2 may be implemented, either fully or partially, by processor 231.

The one or more processors 231 of FIG. 3 generally represents any of a wide variety of processors, including but not limited to one or more digital signal processors (DSPs), general purpose microprocessors, application specific integrated circuits (ASICs), field programmable logic arrays (FPGAs), processing circuitry (including fixed function circuitry and/or programmable processing circuitry), other equivalent integrated or discrete logic circuitry, or some combination thereof. Memory 232 of FIG. 3 may comprise any of a wide variety of volatile or non-volatile memory, including but not limited to random access memory (RAM) such as synchronous dynamic random access memory (SDRAM), read-only memory (ROM), non-volatile random access memory (NVRAM), electrically erasable programmable read-only memory (EEPROM), FLASH memory, and the like. Memory 232 may comprise a computer-readable storage medium for storing audio/video data, as well as other kinds of data. Memory 232 may additionally store instructions and program code that are executed by processor 231 as part of performing the various techniques described in this disclosure.

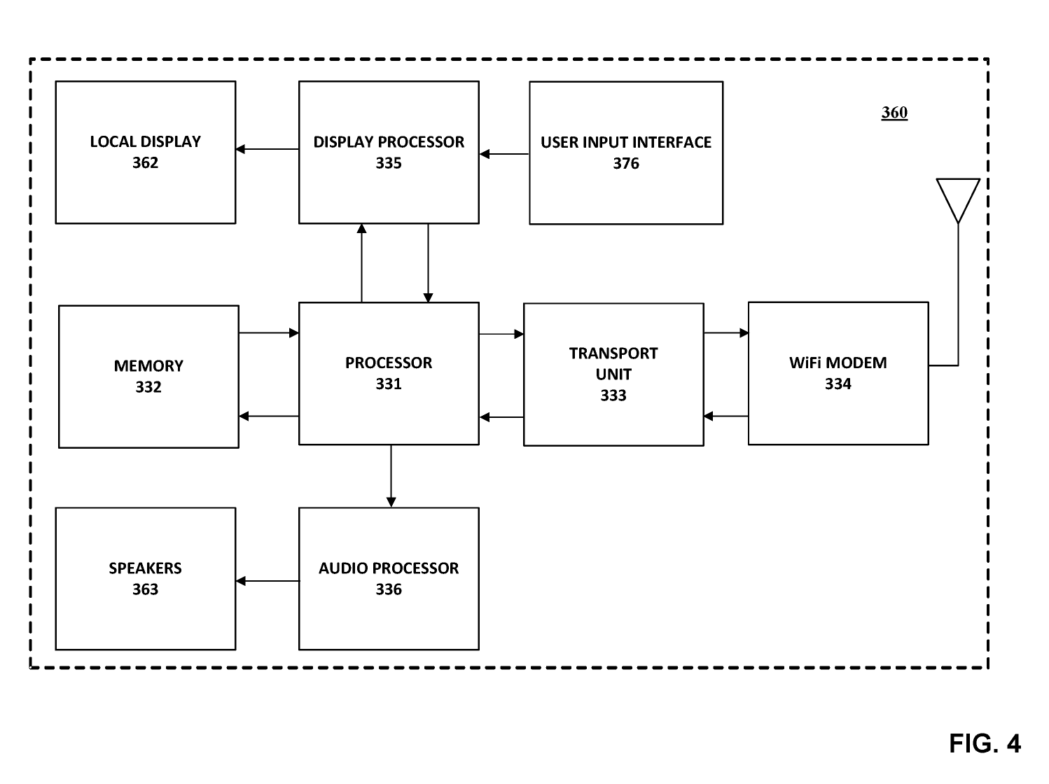

FIG. 4 is a block diagram showing one example of a sink device of a wireless display system that may implement one or more techniques of this disclosure. As illustrated in FIG. 4, a sink device 360, which may be a device similar to sink device 130 in FIG. 2 and may operate in the same manner as sink device 130, may include one or more processors 331, a memory 332, a transport unit 333, a wireless modem 334, a display processor 335, a local display 362, an audio processor 336, a speaker 363, and a user input interface 376. Sink device 360 receives at wireless modem 334 encapsulated data units sent from a source device. Wireless modem 334 may, for example, be a Wi-Fi modem configured to implement one more standards from the IEEE 802.11 family of standards. Transport unit 333 can decapsulate the encapsulated data units. For instance, transport unit 333 may extract encoded video data from the encapsulated data units and send the encoded A/V data to processor 331 to be decoded and rendered for output. Display processor 335 may process decoded video data to be displayed on local display 362, and audio processor 336 may process decoded audio data for output on speaker 363.

In addition to rendering audio and video data, wireless sink device 360 can also receive user input data through user input interface 376. User input interface 376 can represent any of a number of user input devices included but not limited to a touch display interface, a keyboard, a mouse, a voice command module, gesture capture device (e.g., with camera-based input capturing capabilities) or any other of a number of user input devices. User input received through user input interface 376 can be processed by processor 331. This processing may include generating data packets that include the received user input command in accordance with the techniques described in this disclosure. Once generated, transport unit 333 may process the data packets for network transport to a wireless source device over a UIBC.

The one or more processors 331 of FIG. 4 may comprise one or more of a wide range of processors, such as one or more digital signal processors (DSPs), general purpose microprocessors, application specific integrated circuits (ASICs), field programmable logic arrays (FPGAs), processing circuitry (including fixed function circuitry and/or programmable processing circuitry), other equivalent integrated or discrete logic circuitry, or some combination thereof. Memory 332 of FIG. 4 may comprise any of a wide variety of volatile or non-volatile memory, including but not limited to random access memory (RAM) such as synchronous dynamic random access memory (SDRAM), read-only memory (ROM), non-volatile random access memory (NVRAM), electrically erasable programmable read-only memory (EEPROM), FLASH memory, and the like. Memory 232 may comprise a computer-readable storage medium for storing audio/video data, as well as other kinds of data. Memory 332 may additionally store instructions and program code that are executed by processor 331 as part of performing the various techniques described in this disclosure.

Current streaming of data from a source device to a sink device utilizing the Miracast wireless display protocol utilizes a third track that includes PNG/JPEG graphics file format for capturing and rendering subtitle data along with video content. Such Miracast wireless display protocol data streaming methods require that the subtitle be rendered on the screen so that the source device captures subtitle data by performing a screen capture. The captured raw image data is processed to improve efficiency, which involves pixel wise operation to identify transparent pixels. The processed raw image is then encoded and transmitted to the sink device. During the processing of the raw data, PNG encoding is done using software libraries at the source device to convert the raw capture of subtitle data to a PNG image. Similarly, PNG decoding is done at the sink device using software libraries to acquire the raw image data to be displayed, along with upscaling or downscaling may be beneficial given the screen resolution at the source device. One of the problems with the current use of software libraries and combining of subtitle data and video data at the source device is that the data streaming process tends to be time consuming, resulting in frequent streaming errors.

As described below in detail, the present disclosure improves the efficiency of data streaming of subtitle data from a source device to a sink device in a wireless display protocol, such as the Miracast wireless display protocol, by periodically eliminating the need for composing and presenting data onto a display of the source device, eliminating the need for write back by the source device display to provide raw data, eliminating pixel wise operation on raw data to optimize performance, and eliminating the need for PNG/JPEG encoding of subtitle data and/or upward or downward scaling of decoded subtitle data based on screen resolution. In addition, quality of the subtitle data is improved as a subtitle is typically not resized, and is rendered natively at the sink device. As a result, the quality of text is not distorted or skewed as the display at the sink device is typically larger in size and of higher resolution.

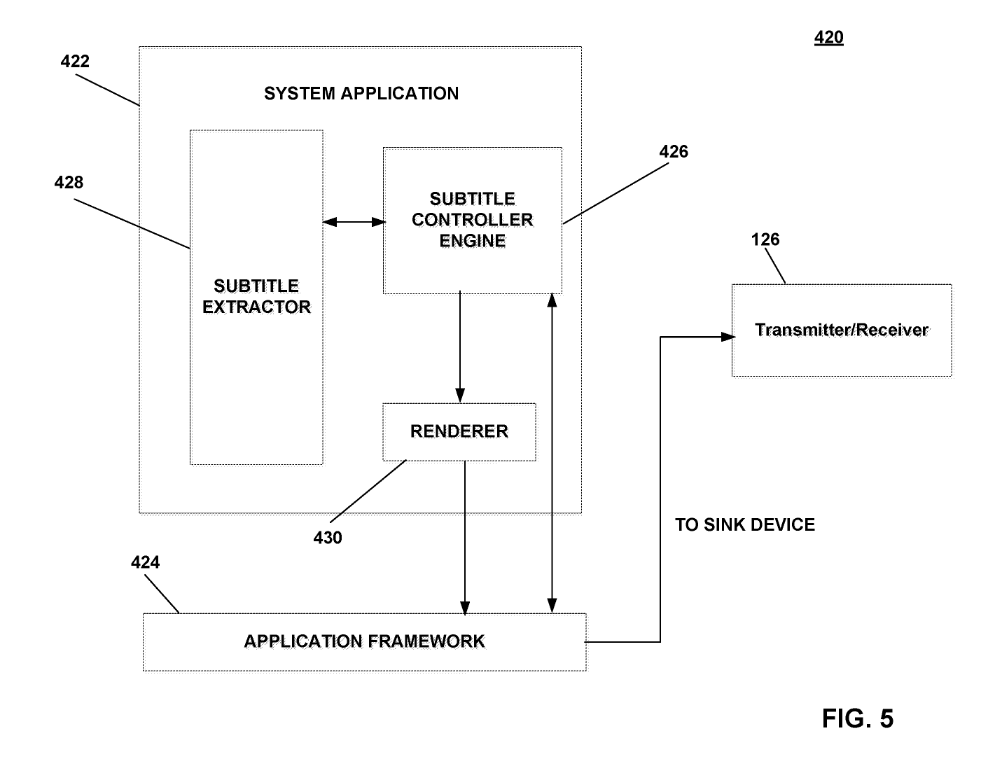

FIG. 5 is a block diagram of a source device of a wireless display system for transmitting subtitle data according to an example of the present disclosure. As illustrated in FIG. 5, audio/video control unit 125 of a source device 420 includes a system application 422 and an application framework 424 for running a software application on the source device 420. During transmission of subtitle data for direct streaming of data, a subtitle controller engine 426 of the system application 422 initiates receipt of subtitle text data from the application framework 424. In response to the received subtitle text data, subtitle controller engine 426 negotiates with the sink device. Once the features have been successfully negotiated, subtitle controller engine 426 transfers the negotiated features to the application framework 424 and captures associated text data via subtitle extractor 428 located within system application 422.

As described herein, an “application framework” (such as application framework 424 of FIG. 5) may include, for example, any one or more application(s) running video on source device 420, and sending subtitle data (e.g., via transmitter/receiver 126) for rendering. In various examples, the negotiation of the features may include negotiation of the subtitle format, including features such as one or more of plug and play (pnp) features, time text markup language (ttml) features, SubRip text (srt) file format features, timed text, web video text tracks (webvtt) features, etc. The negotiation of features enables the sink device (e.g., sink device 130) to inform source device 420 of formats that the sink device can support for rendering the subtitle data. The negotiation of features further enabling source device 420 to transmit data to the sink device in a preferred format (e.g., a “most preferred format” identified by the sink device) after the negotiation is completed. Source device 420 may obtain negotiated features based on the completion of the negotiation of features. The application framework may be changed as the application is running on the source device. A renderer 430 renders the resulting captured subtitle text data and the resulting rendered image is transmitted to the sink device via transmitter/receiver 126. According to one example, renderer 430 may multiplex the captured subtitle text data with one or both of audio data or video data onto a data stream and transmits the multiplexed data stream to the sink device.

The source device (e.g., a renderer or rendering unit thereof) may have access to information related to the subtitle format, such as subtitle data in a text format, and position information (e.g., coordinates) for displaying the text data on the source screen. Therefore, rather than rendering the subtitle data on a source screen, renderer 430 may capture the text data and the position information (e.g., coordinates), and may provide these data to the WFD framework. Based on the format negotiated with the sink device for the subtitles, renderer 430 may either convert the text data (along with the position information), or send these data to the sink device in a native format.

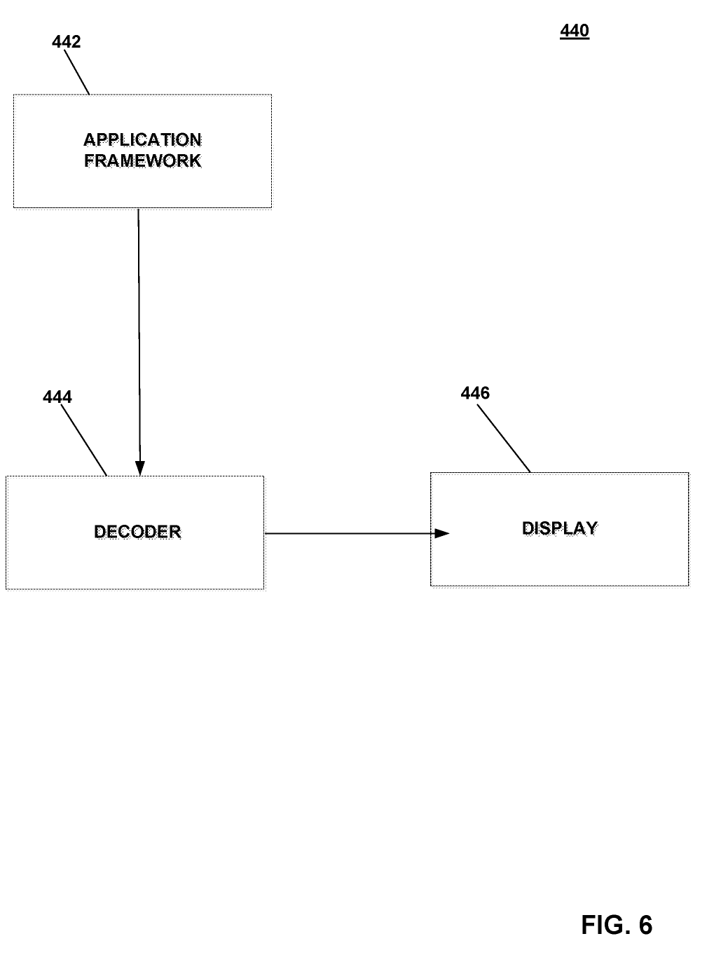

FIG. 6 is a block diagram of a sink device of a wireless display system for transmitting subtitle data according to an example of the present disclosure. As illustrated in FIG. 6, a sink device 440 receives and transfers the subtitle text data to an application framework 442 of the sink device 440 for running a software application on the sink device 440, and a decoder 444 decodes the subtitle text data. The decoded subtitle text data is then displayed by a display 446 of the sink device 440.

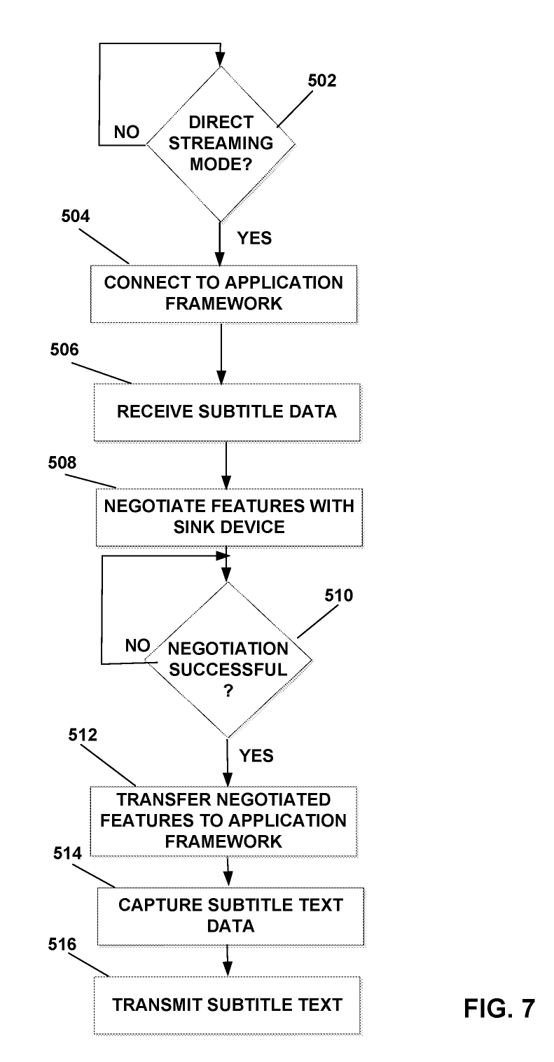

FIG. 7 is a flowchart of a method of transmitting subtitle data in a wireless display system according to an example of the present disclosure. As illustrated in FIG. 7, according to one example of a method of transmitting subtitle data in a wireless display system, the source device 420 determines whether a direct streaming mode has been enabled (Block 502). If direct streaming mode is enabled, the source device 420 connects the application framework 424 (Block 504), and receives subtitle text data the application framework 424 of the source device 420 (Block 506). Upon receipt of the subtitle text data, source device 420 initiates negotiation of features of the subtitle text data, described above, with the sink device 440 (Block 508). In one example, the negotiation of the features may include negotiation of the subtitle format, such as pnp, ttml, etc., so that the sink device may inform the source device as to formats that the sink device may support for rendering the subtitle data, and enable the source device to transmit data to the sink device in a most preferred format after negotiation. Source device 420 may obtain the negotiated features based on the completion of the negotiation of features

Currently in Miracast, the source device requests that the sink device publish its supported audio format and video format. Similarly, the R2 Miracast specification negotiation for subtitle data is limited to png and jpeg. In one example, using the present technique enables the sink device to publish additional subtitle support formats, such as srt, ttml, timed text, webvtt etc. In this way, once a clip is played on the source device and subtitle data available in the clip is matched to the above-mentioned formats, then there is no need to render it on source screen and perform a capture from there. Instead, data can be sent to the sink device in native format and the sink device may read from and render the data.

Once the negotiation is determined by the source device 420 to be successful (Block 510), the source device 420 transfers the resulting negotiated features to the application framework 424 of the source device 420 (Block 512). Using the negotiated features, the source device 420 captures subtitle text data (Block 514), and transmits the captured subtitle text to the sink device 440 (Block 516).

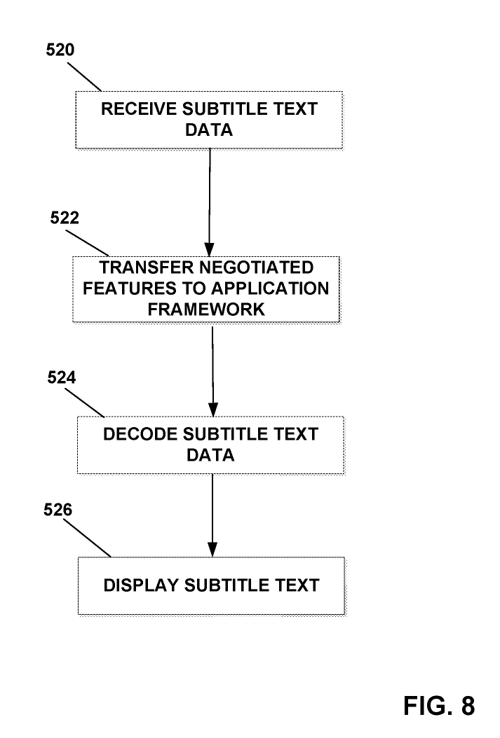

FIG. 8 is a flowchart of a method of transmitting subtitle data in a wireless display system according to an example of the present disclosure. As illustrated in FIG. 8, according to one example of a method of transmitting subtitle data in a wireless display system, the sink device 440 receives the captured subtitle text data (Block 520), and transfers the received captured subtitle text data to the application framework 442 of the sink device 440 (Block 522). According to one example, the sink device 440 transfers the subtitle text data to the application framework 442 (Block 522), at a specified timing according to an audio/video synchronization associated with the sink device 440. The sink device 440 then decodes the received subtitle text data (Block 524), and displays the subtitle text on the display 446 of the sink device 440, (Block 526).

Video is transmitted from the source device to the sink device in display order, since AV synchronization of the player being used on the source device is not exposed or known by the source device. For example, since each playback application is to maintain audio video synchronization that includes logic that is implemented by that application, the source device will not know how that synchronization logic is implemented inside that application. Also, not all applications will provide source code. Therefore, audio video synchronization logic may be an unknown in certain scenarios for the source device. However, for the source device, at a given time, whatever audio+video+text data is available, i.e., audio data at speaker, video data at screen and text data at text renderer, such data occurs after the application's av sync logic is applied. Hence the source device assumes that these are supposed to presented together and maintains this synchronization while sending data to the sink device by applying one timestamp value (same for all three streams), which is a WFD session timestamp.

In addition, the source device takes care of B frames, as depth for it is not communicated to the sink device. Each frame includes a reference to future frames, and each reference may be up to 16 frames, for example, which is known as depth. This depth is only known when decoding is performed. Frame is timestamped as per the WFD Session Timestamp and other tracks are also synchronized based on the timestamp.

The source device generates audio/video/text streams using the WFD Session Timestamp, and therefore needs to maintain a synchronization among the audio/video/text streams so that lip sync is maintained. In order to make this possible, an internal timestamping logic is used, in which the logic starts with a reference time and keeps stamping timestamps to the stream data. Since the logic starts with same reference for all three streams, and keeps stamping incrementally, it is referred to as WFD session timestamp.

In some instances, clip timestamps may be lost during streaming. During direct streaming, each frame may be sent from the source device to the sink device at a time when the particular frame is to be displayed, based on audio/video synchronization of the sink device. Therefore, bi-directional (or ‘B’) frames may need to be processed at the source device. This is because frames would otherwise be streamed to the decoder of sink device in decode order, but the sink device may be configured to process (i.e., expect to receive) the frames in display order. Therefore, the source device transmits the frames to the sink device in display order, to maintain synchronization with Audio/Text track if present.

Because the subtitle data is transmitted as a separate track, rather than being sent as an overlay file, the subtitle data needs to be synchronized with the Audio/Video (or ‘A/V’) track. This information is only included in the playback application being utilized by the source device. Therefore, the text track data needs to be transmitted to the sink device only when the player makes a determination to render the source screen in synchronization to the Audio/Video data. The Player may include a playback application being used on the source device, such as MX player, Gallery, Netflix®, Youtube®, etc. As an initial matter, sending subtitle file to the sink device would require the sink device to synchronize the subtitle file with the Audio/Video data being received. But, as clip timestamps are lost and WFD session timestamps are received, synchronization may be compromised or lost for the text track.

Secondly, a subtitle file may be sent when a complete file is available. However, during streaming, downloaded data may be received, rather than a complete file at once. Thirdly, during performance of a seek operation, i.e., a fast forward or rewind operation, on the video data, the sink device may need information about the seek operation, so that the sink device can move to the correct timestamp in the text file to continue to display text track data in sync. In addition, the video may start from a next I frame, which would be different from the timestamp that would be required.

In current wireless display protocol designs, during the synchronization of the text track with corresponding video data, A/V synchronization logic is available at the Player. Once a video frame is received, the Player queries corresponding subtitle data from the subtitle file, and sends the subtitle data to the subtitle renderer based on the A/V sync window. According to an example of the present disclosure, because the video is being displayed and the corresponding text data is available to the subtitle renderer, timestamping would involve a single timestamp for data on Audio/Video/Text track, and would be decoded in the same way, using a single timestamp by the sink device in order to achieve track synchronizations.

The techniques of this disclosure may be implemented in a wide variety of devices or apparatuses, including a wireless handset, and integrated circuit (IC) or a set of ICs (i.e., a chip set). Any components, modules, or units have been described provided to emphasize functional aspects and does not necessarily require realization by different hardware units.

Accordingly, the techniques described herein may be implemented in hardware, software, firmware, or any combination thereof. If implemented in hardware, any features described as modules, units or components may be implemented together in an integrated logic device or separately as discrete but interoperable logic devices. If implemented in software, the techniques may be realized at least in part by a computer-readable medium comprising instructions that, when executed in a processor, performs one or more of the methods described above. The computer-readable medium may comprise a tangible and non-transitory computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more digital signal processors (DSPs), general purpose microprocessors, an application specific integrated circuits (ASICs), field programmable logic arrays (FPGAs), processing circuitry (including fixed function circuitry and/or programmable processing circuitry), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules configured for encoding and decoding, or incorporated in a combined video codec. Also, the techniques could be fully implemented in one or more circuits or logic elements.

Various aspects of the disclosure have been described. These and other aspects are within the scope of the following claims.

What is claimed is:

1. A method of transmitting subtitle data in a wireless display system, the method comprising:
receiving, at a source device, subtitle information from an application framework running on the source device;
in response to receiving the subtitle information, initiating, by the source device, a negotiation of features associated with the subtitle information between the source device and a sink device;
obtaining, by the source device, negotiated features based on the negotiation of features between the source device and the sink device;
in response to obtaining the negotiated features, capturing, by the source device, subtitle text data in accordance with the negotiated features; and
transmitting, by the source device, the captured subtitle text data to the sink device.

2. The method of claim 1, further comprising multiplexing, by the source device, the captured subtitle text data with one or both of audio data or video data, wherein transmitting the captures subtitle text data to the sink device comprises transmitting the multiplexed subtitle text data to the sink device.

3. The method of claim 1, wherein the application framework running on the source device is a first application framework, the method further comprising:
receiving, at the sink device, the transmitted subtitle text data;
transferring, by the sink device, the received subtitle text data to a second application framework running on the sink device;
rendering, by the sink device, the subtitle text data via the second application framework running on the sink device to form rendered subtitle text; and
outputting, by the sink device, the rendered subtitle text, for display.

4. The method of claim 3, further comprising:
prior to transferring the received subtitle text data to the second application framework running on the sink device, synchronizing, by the sink device, a receipt of the received subtitle text data,
wherein transferring the received subtitle text data to the second application framework running on the sink device comprises transferring the received subtitle text data to the second application framework running on the sink device in response to the synchronization.

5. The method of claim 1,
wherein the source device comprises a mobile device, and
wherein the sink device comprises a display device.

6. The method of claim 5,
wherein the mobile device comprises a smartphone, and
wherein the display device comprises a television.

7. A wireless source device comprising:
a transmitter/receiver configured to couple the wireless source device with a wireless sink device;
a memory configured to store an application framework and subtitle information associated with the application framework; and
one or more processors in communication with the memory and the transmitter/receiver, the one or more processors being configured to:
execute the application framework stored to the memory;
receive the subtitle information from the application framework;
in response to the receipt of the subtitle information, initiate, via the transmitter/receiver, a negotiation of features between the wireless source device and the wireless sink device;
obtain negotiated features based on the negotiation of features;
in response to obtaining the negotiated features, capture subtitle text data in accordance with the set of negotiated features; and
transmit, via the transmitter/receiver, the captured subtitle text data to the wireless sink device.

8. The wireless source device of claim 7,
wherein the memory is further configured to store audio data and video data, and
wherein the one or more processors are further configured to:
multiplex the captured subtitle text data with one or both of the audio data or the video data stored to the memory; and
transmit, via the transmitter/receiver, the multiplexed subtitle text data to the sink device.

9. The wireless source device of claim 7, wherein the wireless source device comprises a smartphone.

10. A wireless display system comprising:
a source device configured to:
obtain subtitle information from a first application framework, the first application framework representing at least one application running on the source device; and
in response to receiving the subtitle information, initiate a negotiation of features associated with the subtitle information; and
a sink device configured to:
complete the negotiation of features initiated by the source device;
receive, from the source device, subtitle text data in accordance with the negotiated features;
transfer the received subtitle text data to a second application framework, the second application framework representing at least one application running on the sink device;
render the subtitle text data using the second application framework to form rendered subtitle text; and
output the rendered subtitle text for display.

11. The wireless display system of claim 10, wherein the source device is further configured to:
obtain the negotiated features based on the completion of the negotiation of features;
in response to obtaining the negotiated features, capture the subtitle text data in accordance with the negotiated features; and
transmit the captured subtitle text data to the sink device.

12. The wireless display system of claim 11,
wherein the source device is further configured to multiplex the captured subtitle text data with one or both of audio data or video data, and
wherein to transmit the captured subtitle text data to the sink device, the source device is configured to transmit the multiplexed subtitle text data to the sink device.

13. The wireless display system of claim 10,
wherein the sink device is further configured to synchronize, prior to the transfer of the received subtitle text data to the second application framework running on the sink device, a receipt of the received subtitle text data, and
wherein to transfer the received subtitle text data to the second application framework running on the sink device, the sink device is configured to transfer the received subtitle text data to the second application framework running on the sink device in response to the synchronization.

14. The wireless display system of claim 10,
wherein the source device comprises a mobile device, and
wherein the sink device comprises a display device.

15. The wireless display system of claim 14,
wherein the mobile device comprises a smartphone, and
wherein the display device comprises a television.

16. A wireless display system comprising:
means for obtaining, at a source device of the wireless display system, subtitle information from a first application framework, the first application framework representing at least one application running on the source device;
means for initiating, at the source device, in response to receiving the subtitle information, a negotiation of features associated with the subtitle information;
means for completing, at a sink device of the wireless display system, the negotiation of features initiated at the source device;
means for receiving, at the sink device and from the source device, subtitle text data in accordance with the negotiated features;
means for transferring, at the sink device, the received subtitle text data to a second application framework, the second application framework representing at least one application running on the sink device;
means for rendering, at the sink device, the subtitle text data using the second application framework to form rendered subtitle text; and
means for outputting the rendered subtitle text for display via the sink device.

17. The wireless display system of claim 16, further comprising:
means for obtaining, at the source device, the negotiated features based on the completion of the negotiation of features;
means for capturing, at the source device, in response to the negotiated features, the subtitle text data in accordance with the negotiated features; and
means for transmitting the captured subtitle text data from the source device to the sink device.

18. The wireless display system of claim 16, further comprising:
means for receiving the transmitted captured subtitle text data at the sink device;
means for transferring the received transmitted captured subtitle text data to an application framework of the sink device;
means for rendering the subtitle text data at the application framework of the sink device to subtitle text; and
means for displaying the rendered subtitle text at the sink device.

19. The wireless display system of claim 18, further comprising
means for multiplexing, at the source device, the captured subtitle text data with one or both of audio data or video data; and
wherein the means for transmitting the captured subtitle text data from the source device to the sink device comprise means for transmitting the multiplexed subtitle text data from the source device to the sink device.

20. The wireless display system of claim 16, further comprising:
means for synchronizing, at the sink device, and prior to any transfer of the received subtitle text data to the second application framework running on the sink device, a receipt of the received subtitle text data,
wherein the means for transferring the received subtitle text data to the second application framework running on the sink device comprises means for transferring, at the sink device, the received subtitle text data to the second application framework running on the sink device in response to the synchronization.
